(19) United States
(12) Patent Application Publication
(10) Pub. No.: US 2009/0014000 A1
(43) Pub. Date: Jan. 15, 2009

(54) Method and apparatus for hands free ventilation in a hazardous environment

(76) Inventor: Paul Robinson, Williston Park, NY (US)

Correspondence Address: WOOD, PHILLIPS, KATZ, CLARK & MORTIMER, 500 W. MADISON STREET, SUITE 3800, CHICAGO, IL, 60661, US

(21) Appl. No.: 11/827,882

(22) Filed: Jul. 13, 2007

(51) Int. Cl. A62B 9/04

(52) U.S. Cl. 128/204.18

(57) ABSTRACT

Hands free ventilation can be provided to a firefighter or other rescue worker in a hazardous environment by connecting an oxygen/air-powered resuscitation/inhalation device (20) to a face piece (12) of an Emergency/Rescue Breathing Apparatus (11) that is being worn by the firefighter or rescue worker. A connector/adapter (40) is provided to allow connection of the oxygen/air-powered resuscitation/inhalation device (20) to a fitment connection (17) on the face piece (12).

### FIELD OF THE INVENTION

This invention relates to face pieces or masks for emergency/rescue breathing apparatus such as Self-Contained Breathing Apparatus (SCBA), air purifying respirators (APR), and powered air purifying respirators (PAPR); and to oxygen/air-powered resuscitation/inhalation devices that are capable of performing hands free cycling ventilation on a victim that has suffered respiratory arrest.

### BACKGROUND OF THE INVENTION

Firefighters and other emergency or rescue workers are routinely called to hazardous environments, such a structural fires, wherein, prior to entering the hazardous environment, the firefighter will typically don a SCBA, which includes a compressed air cylinder that typically provides approximately 30 to 60 minutes of breathable air. In situations where the firefighter becomes lost, trapped or disoriented in a hazardous environment, such as a smoke filled fire building, the firefighter can run out of air before being located and removed. When this happens, the firefighter or rescue worker can suffer respiratory arrest, which will require mechanical ventilation in order to prevent irreversible brain damage which can occur between 1 to 5 minutes without oxygen or death which occurs within 5 to 10 minutes without oxygen. Unfortunately, fire reports have shown that it take an average 17 minutes to remove an unconscious firefighter from the time the firefighter is reported down. Accordingly, there is a need to provide some form of ventilation to a downed firefighter or rescue worker while the downed firefighter or rescue worker is being removed from the hazardous environment.

### SUMMARY OF THE INVENTION

In accordance with one feature of the inventions, a connection adapter is provided for use with a face piece of an emergency/rescue breathing apparatus and an oxygen/air-powered resuscitation/inhalation device. The face piece has an oxygen/air supply connection for a fitment of the emergency/rescue breathing apparatus, and the oxygen/air-powered resuscitation/inhalation device has an oxygen/air ventilation port to deliver an oxygen/air flow to a victim of respiratory failure. The connection adapter includes, a body, an oxygen/air port on the body and configured to engage the oxygen/air ventilation port to direct an oxygen/air flow between the connection adapter and the oxygen/air-powered resuscitation/inhalation device, and a face piece connection on the body and configured to engage the oxygen/air supply connection on the face piece to direct an oxygen/air flow between the face piece and the oxygen/air-powered resuscitation/inhalation device.

As one feature, the face piece connection includes a male bayonet connection surrounded by a gasket.

In one feature, the oxygen/air port includes a threaded male connection.

As one feature, the oxygen/air port includes a resilient cylindrical tube.

In accordance with one feature of the invention, a connection adapter is provided for an oxygen/air-powered resuscitation/inhalation device. The adapter includes a connection configured to engage a face piece of an emergency/rescue breathing apparatus to direct an oxygen/air flow between the oxygen/air-powered resuscitation/inhalation device the face piece. In a further feature, the connection includes a male bayonet connection surrounded by a gasket.

According to one feature of the invention, an oxygen/air-powered resuscitation/inhalation device is provided for use with the face piece of an emergency/rescue breathing apparatus. The oxygen/air-powered resuscitation/inhalation device includes a connection configured to engage the face piece to direct an oxygen/air flow between the oxygen/air-powered resuscitation/inhalation device and the face piece. In a further feature, the connection includes a male bayonet connection surrounded by a gasket.

In accordance with one feature of the invention, a hands free ventilation system is provided to apply mechanical ventilation to a victim in a hazardous environment. The system includes a face piece of an emergency/rescue breathing apparatus, an oxygen/air-powered resuscitation/inhalation device, and a connection adapter configured to connect the oxygen/air-powered resuscitation/inhalation device to the face piece to direct an oxygen/air flow therebetween.

As one feature, the face piece includes an oxygen/air supply connection for a fitment of the emergency/rescue breathing apparatus, and the connection adapter includes a face piece connection configured to engage the oxygen/air supply connection on the face piece to direct the oxygen/air flow between the face piece and the oxygen/air-powered resuscitation/inhalation device. In a further feature, the face piece connection includes a male bayonet connection surrounded by a gasket. In yet another feature, the oxygen/air-powered resuscitation/inhalation device includes an oxygen/air ventilation port, and the connection adapter includes an oxygen/air port configured to engage the ventilation port.

In accordance with one feature of the invention, a method is provided for hands free ventilation in a hazardous environment to a victim wearing an emergency/rescue breathing apparatus including a face piece and a fitment of the emergency/rescue breathing apparatus connected to the face piece. The method including the steps of disconnecting the fitment from the face piece, and connecting an oxygen/air-powered resuscitation/inhalation device to the face piece in place of the fitment.

In accordance with one feature of the invention, a method is provided for hands free ventilation in a hazardous environment to a victim wearing a self contained breathing apparatus including a face piece. The method includes the step of connecting an oxygen/air-powered resuscitation/inhalation device to the face piece.

### BRIEF DESCRIPTION OF THE DRAWINGS

In FIG. 1 is a perceptive view of a firefighter wearing a SCBA;

FIG. 2 is a somewhat diagrammatic perceptive view of a hands free mechanical ventilator in the form of an oxygen/air-powered resuscitation/inhalation device known in the prior art;

FIG. 3 partially broken, side elevation view of the oxygen/air-powered resuscitation/inhalation device of FIG. 2 incorporating a connection adapter according to the invention;

FIG. 4 is a perceptive view showing the device of FIG. 3 prior to being engaged with the face piece or mask of an SCBA; and

FIG. 5 is a perceptive view showing the device of FIG. 3 connected to the face piece or mask of FIG. 4.

### DETAILED DESCRIPTION OF THE ILLUSTRATED EMBODIMENT

With reference to FIG. 1, a firefighter 10 is shown wearing protective garments and an emergency/rescue breathing apparatus in the form of a Self-Contained Breathing Apparatus (SCBA) 11 that includes a face piece or mask 12, an oxygen/air tank 14 containing a pressurized supply of oxygen/air, a fitment 16 in the form of an oxygen/air regulator sealably engaged with an oxygen/air supply connection in the form of a regulator connection 17 of the face piece 12, and an oxygen/air hose 18 connecting the tank 14 to the regulator 16 to supply an oxygen/air flow from the tank 14 to the regulator 16. It should be appreciated that there are many known and suitable forms of SCBAs that can be used with the invention, and that the details of the constructions of the particular components are not critical to the invention. Accordingly, further description of the components of the SCBA will not be provided herein, except for selected details of the face piece or mask 12.

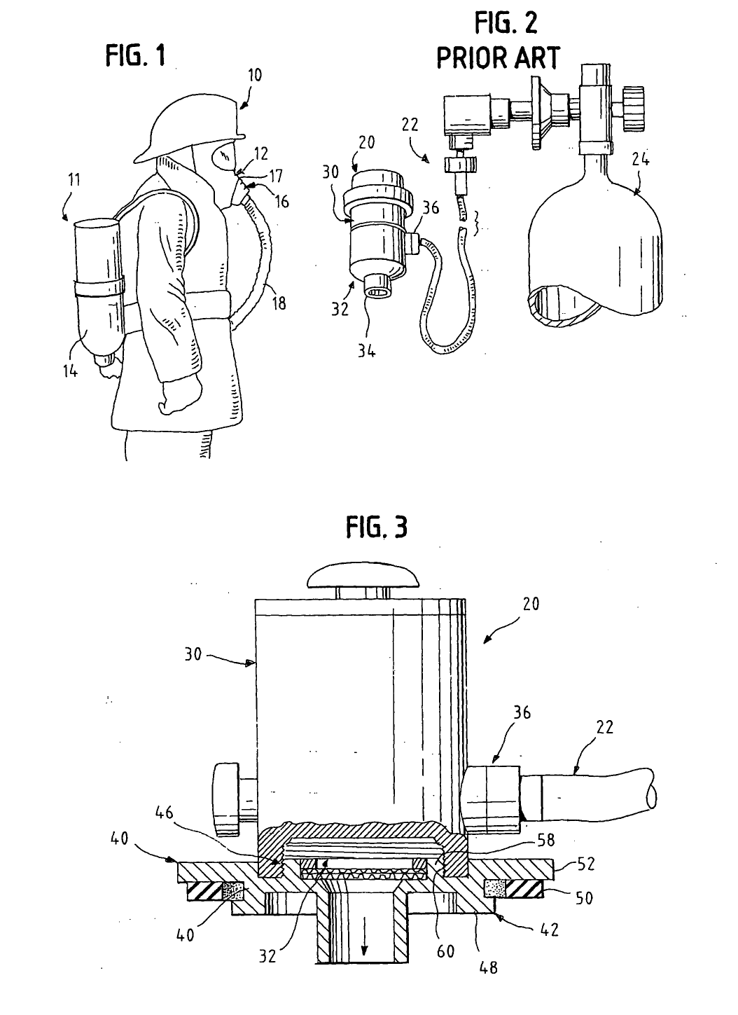

With preference to FIG. 2, a hands free mechanical ventilator is shown in the form of an oxygen/air-powered resuscitation/inhalation device 20 connected by an oxygen/air hose and regulator 22 to a tank 24 containing a pressurized supply of oxygen/air. The device 20 is designed to replace Bag-Valve Mask (BVM) devices during CPR/resuscitation and transport and requires no power source other than the pressurized air supply from the tank 24 to provide hands free mechanical ventilation to a victim of respiratory arrest. These devices are conventionally applied either through a resuscitation mask that covers the nose and mouth of a victim or via an airway connection such as an endotracheal tube (ET-tube). One widely used oxygen/air-powered resuscitation/inhalation device 20 is marketed under the trademark OXYLATOR® by Lifesaving Systems, Inc. of Roswell, Ga. One form of this device is described in U.S. Pat. No. 5,230,330 entitled, “Resuscitation and Inhalation Device”, issued Feb. 19, 1991 to William E. Price, the entire disclosure which is incorporated herein by reference.

The device 20 includes a housing 30 having an oxygen/air ventilation port, shown generally at 32, for supplying an oxygen/air flow to a victim of respiratory arrest. The port 32 typically includes a cylindrical nipple 34 that can receive a resilient tube of either a nose/mouth covering resuscitation mask or an ET-tube, neither of which are shown. The housing 30 also includes a hose fitting 36 for connection to the oxygen/air hose 22.

As proposed herein, hands free ventilation can be provided to a firefighter or other rescue worker 10 in a hazardous environment by connecting the device 20 to the face piece 12. In this regard, with reference to FIG. 4, it can be seen that when the regulator 16 is removed from the face piece 12, the regulator connection 17 is made available for connection to another fitment, which in the embodiment shown in FIGS. 3 and 4 is provided in the form of a connection adapter 40 engaged with the ventilation port 32 of the device 20 and having a face piece connection 42 configured to engage the regulator connection 17 of the face piece 12 to direct an oxygen/air flow between the face piece 12 and the device 20. As illustrated, the adapter 40 also includes a body 44, and an oxygen/air port 46 on the body and configured to engage the port 32 to direct the oxygen/air flow between the device 20 and the connection adapter 40. In the illustrated embodiment, the connection 42 includes a male bayonet connection 48 surrounded by a suitable gasket 50 supported by an annular flange 52 and is configured to engageably mate with a female bayonet connection 54 and a gasket engaging surface 56 of the regulator connection 17 on the face piece 12. While the illustrated bayonet type connections are typical, it was be appreciated that the adapter 40 can utilize any type of suitable connection that will mate with the particular type of the connection used for the regulator connection 17 of the mask 12. As illustrated in FIG. 3, the oxygen/air port 46 of the adapter 40 is provided in the form of a threaded, cylindrically, male nipple 58 that engages in a threaded female opening 60 in the housing 30 of the device 20. Again, it will be appreciate that the oxygen/air port 46 can be of any suitable form that can sealingly engage with the particular type of oxygen/air ventilation port 32 provided on the device 20. For example, the oxygen/air port 46 could be provided in the form of a resilient tube that engages over the cylindrical nipple 34 of the device 20 shown in FIG. 2. Furthermore, it should also be appreciated that in some applications it may be desirable to integrate the face piece connection 42 as part of the housing 30 of the device 20.

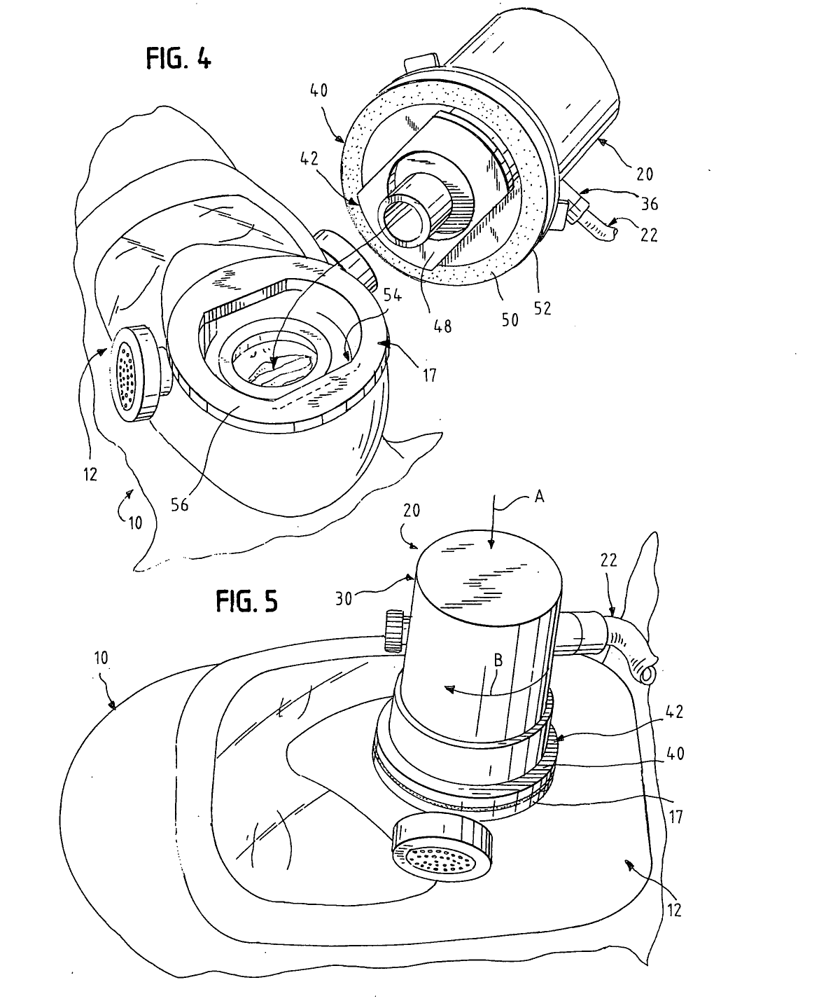

In operation, hands free ventilation of a downed firefighter or rescue worker in a hazardous environment is provided by disconnecting the regulator 16 from the face piece 12 and connecting the device 20 to the face piece 12 in place of the regulator 16 via the adapter. As shown in FIG. 5, for the bayonet type connectors, this is accomplished by pushing the device 20 downwards while twisting the device 20 one quarter turn to engage the bayonet connection 17 and 42, as shown by the arrows A and B in FIG. 5.

It should be appreciated that while the oxygen/air supply connection 17 on the face piece 12 is shown for use with the regulator 16 of the SCBA 11, it can also be used with other types of fitments, such as for example, an air purifying filter device. In this regard, face piece 12 could be the face piece of an Air Purifying Respirator (APR) or a Powered Air Purifying Respirator (PAPR) to which the air purifying filter device of the APR or PAPR is connected to supply a purified oxygen/air flow. In view of this, it should be understood that the term “emergency/rescue breathing apparatus” is used herein to mean an SCBA, an APR, or a PAPR.

It should also be appreciated that while the preferred form of the connection adapter 40 illustrated in the figures is configured for engagement with the oxygen/air supply connection 17 of the face piece 12, in some applications it may be desirable for the connection adapter 40 to be configured to engage a different connection provided on the face piece 12 which could still serve as a port to supply oxygen/air to a user wearing the face piece 12. In this regard, it is even possible for a connection to be provided on the face piece 12 that is specifically designed and reserved for use with the connection adapter 40.

1. A connection adapter for use with a face piece of an emergency/rescue breathing apparatus and an oxygen/air-powered resuscitation/inhalation device, the face piece having an oxygen/air supply connection for a fitment of the emergency/rescue breathing apparatus, the oxygen/air-powered resuscitation/inhalation device having an oxygen/air ventilation port to deliver an oxygen/air flow to a victim of respiratory failure; the connection adapter comprising:
a body;
an oxygen/air port on the body and configured to engage the oxygen/air ventilation port to direct an oxygen/air flow between the connection adapter and the oxygen/air-powered resuscitation/inhalation device; and
a face piece connection on the body and configured to engage the oxygen/air supply connection on the face piece to direct an oxygen/air flow between the face piece and the oxygen/air-powered resuscitation/inhalation device.

2. The connection adapter of claim 1 wherein the face piece connection comprises a male bayonet connection surrounded by a gasket.

3. The connection adapter of claim 2 wherein the oxygen/air port comprises a threaded male connection.

4. The connection adapter of claim 3 wherein the oxygen/air port comprises a resilient cylindrical tube.

5. A connection adapter for an oxygen/air-powered resuscitation/inhalation device, the adapter comprising a connection configured to engage a face piece of an emergency/rescue breathing apparatus to direct an oxygen/air flow between the oxygen/air-powered resuscitation/inhalation device the face piece.

6. The oxygen/air powered resuscitation/inhalation device of claim 5 wherein the connection comprises a male bayonet connection surrounded by a gasket.

7. An oxygen/air-powered resuscitation/inhalation device for use with the face piece of an emergency/rescue breathing apparatus, the oxygen/air-powered resuscitation/inhalation device comprising a connection configured to engage the face piece to direct an oxygen/air flow between the face piece and the oxygen/air-powered resuscitation/inhalation device.

8. The oxygen/air powered resuscitation/inhalation device of claim 7 wherein the connection comprises a male bayonet connection surrounded by a gasket.

9. A hands free ventilation system for use in providing mechanical ventilation to a victim in a hazardous environment, the system comprising:
a face piece of an emergency/rescue breathing apparatus;
an oxygen/air-powered resuscitation/inhalation device; and
a connection adapter configured to connect the oxygen/air-powered resuscitation/inhalation device to the face piece to direct an oxygen/air flow therebetween.

10. The system of claim 9 wherein:
the face piece comprises an oxygen/air supply connection for a fitment of the emergency/rescue breathing apparatus; and
the connection adapter comprises a face piece connection configured to engage the oxygen/air supply connection on the face piece to direct the oxygen/air flow between the face piece and the oxygen/air-powered resuscitation/inhalation device.

11. The system of claim 10 wherein the face piece connection comprises a male bayonet connection surrounded by a gasket.

12. The system of claim 9 wherein:
the oxygen/air-powered resuscitation/inhalation device comprises an oxygen/air ventilation port; and
the connection adapter comprises an oxygen/air port configured to engage the ventilation port.

13. A method for providing hands free ventilation in a hazardous environment to a victim wearing an emergency/rescue breathing apparatus including a face piece and a fitment of the emergency/rescue breathing apparatus connected to the face piece, the method comprising the steps of:
disconnecting the fitment from the face piece; and
connecting an oxygen/air-powered resuscitation/inhalation device to the face piece in place of the fitment.

14. A method for providing hands free ventilation in a hazardous environment to a victim wearing an emergency/rescue breathing apparatus including a face piece, the method comprising the step of connecting an oxygen/air-powered resuscitation/inhalation device to the face piece.
